(19) United States
(12) Patent Application Publication
(10) Pub. No.: US 2005/0097080 A1
(43) Pub. Date: May 5, 2005

(54) System and method for automatically locating searched text in an image file

(76) Inventors: Amarender Reddy KethiReddy, Fountain Valley, CA (US); Hanzhong Zhang, Westminster, CA (US)

Correspondence Address: Gerald W. Maliszewski, P.O. Box 270829, San Diego, CA, 92198-2829, US

(21) Appl. No.: 10/696,801

(22) Filed: Oct. 30, 2003

(51) Int. Cl. G06F 17/30

(52) U.S. Cl. 707/3

(57) ABSTRACT

A system and method is provided for locating searched terms in an image file received from a search engine. The method comprises: submitting a search term to a search engine having an indexed file database of image files, for example, a text search term such as a keyword, ASCII symbols, word patterns, or data patterns; receiving an indexed file cross-referencing image indexed files to the search term, for example, the image files may be a tagged image file format (TIFF) or portable document (PDF) format document; performing optical character recognition (OCR) on the selected image file; locating coordinates in the image file corresponding to the search term; and, automatically displaying the image file at the coordinates. Typically, the location process causes the search term to be displayed, or even highlighted.

### BACKGROUND OF THE INVENTION

1. Field of the Invention

This invention generally relates to digital text and image document processing and, more particularly, to a system and method for automatically locating a search term in an image file received from a search engine.

2. Description of the Related Art

Network-connected search engines have become an important research tool. Using a browser, for example an Internet Explorer browser loaded on a personal computer, a user can submit a search term to a search engine, such as www.Google.com, via an Internet connection. Typically, the browser or main application is associated with a user interface (UI), such as a keyboard/mouse and display screen, for entering search text to the search engine. A search is performed and the results are displayed in the application view. When the link in the search results is clicked, an associated application is launched and hits (matched text) are highlighted. For example, if a PDF file is selected, an Acrobat application is launched. Likewise, for document and TIF files, a Microsoft Word application is launched. In case of image files, an optical character recognition (OCR) operation is typically performed on the image file and the hits are highlighted in the OCR processed document.

If the search term is found in a text document, such as a document is a Word format, a search for the term is performed by the main application. Even though the search engine does not provide pointers to the search terms in the returned text document, the main application, or a document processing application launched by the main application, can quickly search the text document for text search terms. However, the search for terms in an image document is more difficult. There is no way to directly access the image document to search for terms. If the search term is text, an OCR process must be performed to locate the term. The OCR process is computationally intensive and, therefore, relatively slow.

To reduce the computation time associated with searching for terms in an image file, a search engine may maintain a library of indexed files that cross-reference various terms, phrases, or keywords to image files. Such a library would require that an OCR process have already been performed upon the image files. Alternately, the search engine must perform the OCR process on image documents at the time of the search request. Either way, if the search engine returns an image document in response to a search request, the search engine does not provide any pointers with the file to help the main application automatically locate the terms.

If a user selects an image file returned by the search engine, the user must open the file and manually search for the term, or open an application capable of performing the OCR operation. Then, a search can be made of the OCR converted document. Either way, it takes a considerable amount of time and effort for a user to deal with these image files.

It would be advantageous if a search term could automatically be located and displayed in an image file that is supplied by a search engine.

### SUMMARY OF THE INVENTION

The present invention uses an OCR engine capable of retrieving the coordinates of matched word(s) (hits) in an image file, and supplying the coordinates to a main application, which displays the search results. The main application also launches an image file viewer capable of opening the image file. By using coordinates supplied by OCR engine, the viewer highlights the occurrences of the hits in the image file itself, as opposed to an OCR converted version of the image file.

Accordingly, a method is provided for locating searched terms in an image file received from a search engine. The method comprises: submitting a search term to a search engine having an indexed file database of image files. For example, the search term may be keyword, ASCII symbol, word pattern, or data pattern. The method further comprises: receiving an indexed file cross-referencing image files to the search term. The image files may be a tagged image file format (TIFF) or portable document (PDF) format documents, for example. The method further comprises: performing optical character recognition (OCR) on the selected image file; locating coordinates in the image file corresponding to the search term; and, automatically displaying the image file at the coordinates. Typically, this means that the search term will be displayed, or even highlighted.

As is typical with most search engines, the process begins with the acceptance of a search term at a user interface (UI), such as a personal computer (PC) having a display, keyboard, and mouse. A main application associated with the PC submits the search term, via the Internet for example. A search will usually return an indexed file that references several image and/or text documents for display at the UI. If the user selects an image document, a viewer application is opened corresponding to the image document format. The viewer application, in turn, launches an OCR engine. Then, locating coordinates in the image file corresponding to the search term includes the OCR engine supplying the coordinates in the selected image file to the viewer application. The viewer application may highlight the text at the coordinates supplied by the OCR engine.

Additional details of the above-described method and a system for locating search terms in an image file received from a search engine are provided below.

### BRIEF DESCRIPTION OF THE DRAWINGS

FIG. 1 is a schematic block diagram of the present invention system for locating search terms in an image file received from a search engine.

FIG. 2 is a diagram depicting a portion of an indexed file returned from a search engine in response to submitting the search term “tennis racquet”.

FIG. 3 is a diagram depicting an exemplary automatic search term location result.

FIG. 4 is a flow diagram illustrating the process of displaying image file search term highlighting.

FIG. 5 is flowchart illustrating the present invention method for locating searched terms in an image file received from a search engine.

### DETAILED DESCRIPTION OF THE PREFERRED EMBODIMENTS

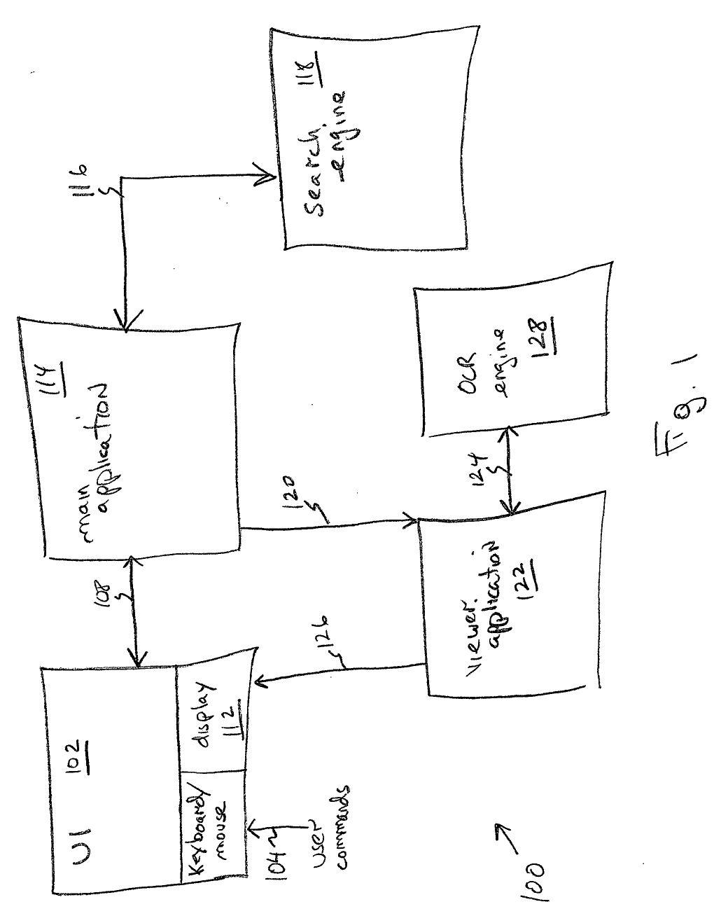

FIG. 1 is a schematic block diagram of the present invention system for locating search terms in an image file received from a search engine. The system 100 comprises a user interface (UI) 102 having an input on line 104 to accept user commands and an applications interface on line 108. A typical UI 102 would include a keyboard and/or mouse 110 and a display 112. However, other means of data entry, feedback, and selection are also known.

A main application 114 has an interface on line 108 to accept a search term and image file selections made from the UI 102, and to supply the search term to a search engine with an indexed file database of image files. The main application 114 can be a conventional browser or an image processing application, such as Sharpdesk™ for example. Typically, the search term is supplied over a network 116 connected to a search engine 118, capable of Internet or email-type communications. Alternately, the network can represent an Intranet link, a connection to a server (not shown), or a connection to a local memory (not shown). The invention is not limited to any particular communication protocol or image file source. From the network 116, the main application 114 receives an indexed file cross-referencing image files, as well as text files, to the search term. For example, a page showing the first 10 of 128 hits may be shown on the display 112.

Thus, it is typical that the main application 114 receives a plurality of image file references corresponding to the search term. The main application 114 receives a command from the UI 102 selecting an image file from among the plurality of image file references. Once an image file has been selected, the selection is sent to the search engine. The search engine 118 supplies the selected image file to the main application 114 on line 120.

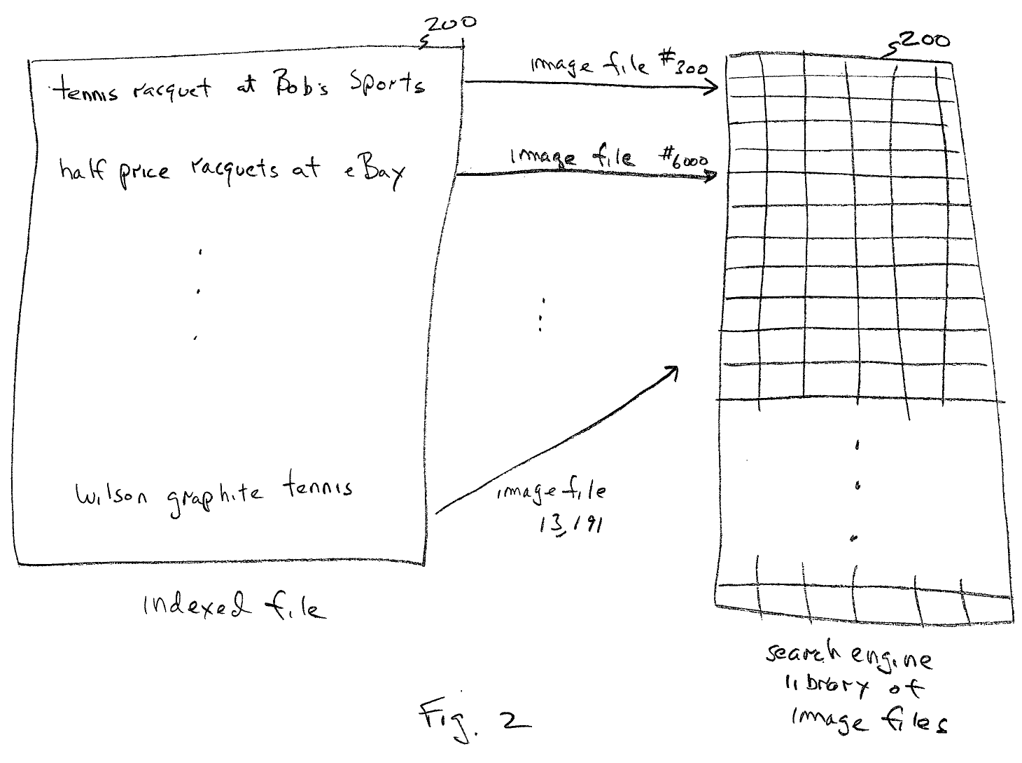

FIG. 2 is a diagram depicting a portion of an indexed file returned from a search engine in response to submitting the search term “tennis racquet”. The indexed file 200 would be shown on the UI display (see reference designator 112, FIG. 1). In response to a user selecting a file from the indexed file 200, that file is retrieved from the search engine library of image files 202.

Returning to FIG. 1, a viewer application 122 has an interface on line 120 to accept the selected image file, and an interface on line 124 to accept located coordinates in the image file corresponding to the search term. The viewer application 122 automatically supplies the image file, at the coordinates, for display on line 126. In some aspects, the viewer application 122 automatically supplies the search term, located at the image file coordinates, for display. In other aspects, the viewer application 122 automatically supplies a highlighted search term, located at the image file coordinates, for display.

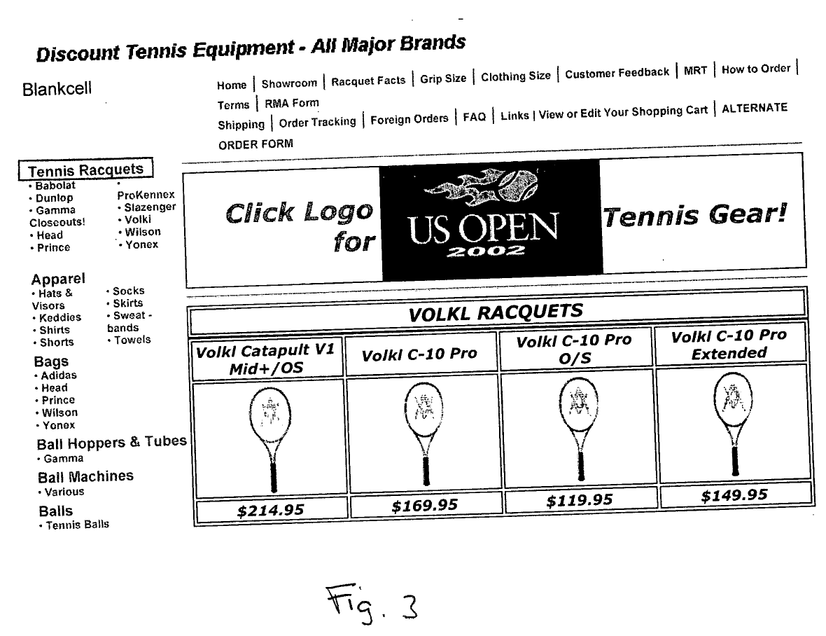

FIG. 3 is a diagram depicting an exemplary automatic search term location result. In this example, the term “tennis racquets” has been located in an image file. The location process has placed the search term approximately one-third of the overall vertical page distance from the top margin, but no attempt has been made to locate the term in the center of the page, with respect to the left and right margins. Also in this example, the search term has been highlighted with a box drawn around the term. In other aspects of the invention, the search term can be located in either the exact center of the page, with respect to the top/bottom margins and/or left/right margins. If the search term of FIG. 3 were centered with respect to the left/right margins, then a portion of the right page might be located “off” the screen, or the overall page would have to be scaled down in size to show the right side of the page. Further, the page can be scaled to a predefined number of words, or space, to the top, bottom, left, and/or right of the search term. The term need not necessarily be highlighted, especially if the image file shown is scaled to center the search term in the center of the display. Alternately, the search term can be highlighted with a contrasting color, by underlining, bolding, of causing the term to oscillate in appearance, to name but a few examples.

Retuning to FIG. 1, an OCR engine 128 has an interface on line 124 to receive the search term and to receive the selected image file. The viewer application 122 launches the OCR engine 128, prior to supplying the selected image file. The OCR engine 128 supplies search term coordinates on line 124 located in response to performing an OCR operation on the selected image file. More specifically, the OCR engine 128 locates a sequence of bytes in the image file corresponding to the search term and supplies the byte sequence location to the viewer application 122.

It can be appreciated that the above-mentioned system 100 may exist in the context of a PC that includes memory to store applications enabled as software routines, and a microprocessor to perform the manipulation required by the software code. However, elements of the system could be enabled on other platforms, or as a state machine. It can also be appreciated that many of the above-mentioned interfaces can be enabled through sharing a common address/data bus.

Typically, the UI 102 supplies a text search term to the main application 114. For example, the search term can be a keyword, or combination of keywords connected by logical operators, ASCII symbols, word patterns, or data patterns. In a special application of the system an image search term, for example an image, can be used. Then, the OCR engine 128 must have the capability to find and locate images as well as text.

The main application 114 may receive image files in a format such as tagged image file format (TIFF) or portable document (PDF) formats. Then, the viewer application 122 would actually be a plurality of viewer applications, each viewer application corresponding to image file format. The present invention system 100, is not necessarily limited to just the above-mentioned formats, however. Alternately, the viewer application may be a single application capable of handling a plurality of different file formats.

### Functional Description

Scanned documents can be stored in one of several image formats such as TIFF or PDF. The text from such an image file is typically extracted using OCR technology, and the extracted text is exported in different formats.

In order to search the image documents for the occurrences of specific words(s), an indexing operation is typically performed on the documents (both image and non-image files). The indexing process extracts words from the documents. If the document is an image file, the OCR process must be used to extract the words. The words are stored in a database or in disk files. When a search is submitted seeking the occurrence of specific word(s), the index database of words is searched, and matching documents are shown in the search results view of the application. Typically, the search results view contains link(s) or thumbnails to the matching documents. When clicked, or double clicked, the document is opened in the associated application. For non-image files the search word can be highlighted.

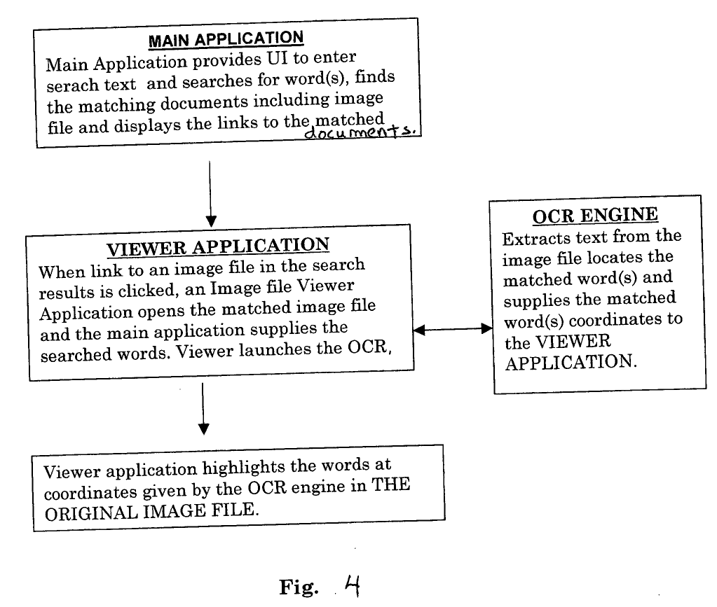

FIG. 4 is a flow diagram illustrating the process of displaying image file search term highlighting. Since image files are a sequenced array of bytes, in order to highlight a word in image file, the exact coordinates of the word are needed. The image file opening application can also have the capability of highlighting the word at given coordinates. The present invention uses an OCR engine capable of performing OCR operations “on the fly” (in memory) and giving coordinates of matched word to the viewer application. The viewer application highlights the matched word at supplied coordinates in the original image file, as opposed to supplying coordinated in the OCR converted image file.

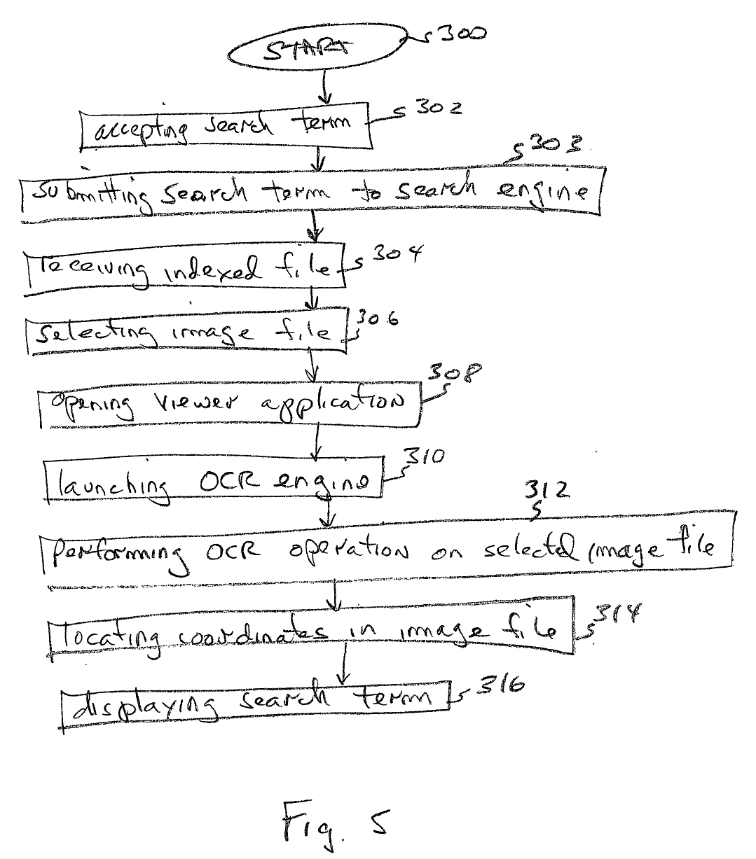

FIG. 5 is flowchart illustrating the present invention method for locating searched terms in an image file received from a search engine. Although the method is depicted as a sequence of numbered steps for clarity, no order should be inferred from the numbering unless explicitly stated. It should be understood that some of these steps may be skipped, performed in parallel, or performed without the requirement of maintaining a strict order of sequence. The method starts at Step 300.

Step 302 accepts a search term at a user interface (UI). Step 303 submits a search term to a search engine having an indexed file database of image files. In some aspects, submitting a search term to a search engine includes submitting the search term, accepted at the UI, from a main application, to the search engine. Step 304 receives an indexed file that cross-references image files to the search term. Step 306, in response to receiving an indexed file cross-referencing image files to the search term, selects an image file at the UI. Step 308 opens a viewer application. Step 310, in response to opening the viewer application, launches an OCR engine. Step 312 performs an OCR operation on a selected image file. In some aspects it can be said that an OCR operation is performed on the selected image file in response to launching the OCR engine.

Step 314 locates coordinates in the image file corresponding to the search term. Step 316 automatically displays the image file at the coordinates. In some aspects of the method, Step 316 displays the search term located at the image file coordinates. In other aspects, Step 316 highlights the displayed search term located at the image file coordinates. As noted above, there are many different aspects to the concept of locating and/or highlighting a search term.

In some aspects of the method, performing an OCR operation on the image file in Step 312 includes performing an OCR operation on an image file in a format such as TIFF or PDF formats. It should be understood that the supported file formats are limited by the capability of the OCR engine.

Typically, submitting a search term in Step 303 includes submitting a text search term. In other aspects, the search term can be a keyword, a group of keywords, keywords connected by logical operators, ASCII symbols, word patterns, or data patterns. A data pattern might be a group of numbers, a range of numbers, or a combination of numbers with letters, for example.

In some aspects, locating coordinates in the image file corresponding to the search term in Step 314 includes the OCR engine supplying the coordinates to the viewer application. In other aspects, Step 314 locates a sequence of bytes in the image file. There are several methods known in the art for locating byte sequences in a document or file. Then, automatically displaying the image file at the coordinates in Step 316 includes the viewer application highlighting the text at the coordinates supplied by the OCR engine.

In other aspects, receiving an indexed file cross-referencing image files to the search term in Step 304 includes receiving a plurality of image file references. Then, selecting an image file in Step 306 includes selecting an image file from among the plurality of received image file references. In some aspects, opening a viewer application in Step 308 includes opening a viewer application, selected from a plurality of viewer applications, in response to the format of the selected image file.

A system and have been provided for automatically displaying search terms from an image file that is received from a source such as a search engine. A few examples have been given to illustrate some typical location operations. Other examples have been given to illustrate the types of terms that can be search and the type of image files that can be referenced. However, the invention is not limited to merely these examples. Other variations and embodiments of the invention will occur to those skilled in the art.

1. A method for locating searched terms in an image file received from a search engine, the method comprising:
submitting a search term to a search engine having an indexed file database of image files;
receiving an indexed file that cross-references image files to the search term;
performing an optical character recognition (OCR) operation on a selected image file;
locating coordinates in the image file corresponding to the search term; and,
automatically displaying the image file at the coordinates.

2. The method of claim 1 wherein automatically displaying the image file at the coordinates includes displaying the search term located at the image file coordinates.

3. The method of claim 2 wherein displaying the search term located at the image file coordinates includes highlighting the displayed search term located at the image file coordinates.

4. The method of claim 1 wherein performing an OCR operation on the image file includes performing an OCR operation on an image file in a format selected from the group including tagged image file format (TIFF) and portable document (PDF) formats.

5. The method of claim 1 wherein submitting a search term includes submitting a text search term.

6. The method of claim 1 wherein submitting a search term includes submitting a search term selected from the group including keywords, ASCII symbols, word patterns, and data patterns.

7. The method of claim 3 further comprising:
accepting a search term at a user interface (UI); and,
wherein submitting a search term to a search engine includes submitting the search term, accepted at the UI, from a main application.

8. The method of claim 7 further comprising:
in response to receiving an indexed file cross-referencing image files to the search term, selecting an image file at the UI;
opening a viewer application;
in response to opening the viewer application, launching an OCR engine; and,
wherein performing an OCR operation on the image file includes performing an OCR operation on the selected image file in response to launching the OCR engine.

9. The method of claim 8 wherein locating coordinates in the image file corresponding to the search term includes the OCR engine supplying the coordinates to the viewer application.

10. The method of claim 9 wherein automatically displaying the image file at the coordinates includes the viewer application highlighting the text at the coordinates supplied by the OCR engine.

11. The method of claim 10 wherein receiving an indexed file cross-referencing image files to the search term includes receiving a plurality of image file references; and,
wherein selecting an image file includes selecting an image file from among the plurality of received image file references.

12. The method of claim 11 wherein opening a viewer application includes opening a viewer application, selected from a plurality of viewer applications, in response to the format of the selected image file.

13. The method of claim 1 wherein locating coordinates in the image file corresponding to the search term includes locating a sequence of bytes in the image file.

14. A system for locating search terms in an image file received from a search engine, the system comprising:
a user interface (UI) having an input to accept user commands, a display, and an applications interface;
a main application having an interface to accept a search term and image file selections from the UI, to supply the search term to a search engine indexed file database of image files, to receive an indexed file cross-referencing image files to the search term, and to supply a selected image file;
a viewer application having an interface to accept the selected image file, to accept located coordinates in the image file corresponding to the search term, and to automatically supply the image file at the coordinates for display; and,
an optical character recognition (OCR) engine having an interface to receive the search term, to receive the selected image file, and to supply search term coordinates located in response to performing OCR on the selected image file.

15. The system of claim 14 wherein the viewer application automatically supplies the search term, located at the image file coordinates, for display.

16. The system of claim 15 wherein the viewer application automatically supplies a highlighted search term, located at the image file coordinates, for display.

17. The system of claim 14 wherein main application receives image files in a format selected from the group including tagged image file format (TIFF) and portable document (PDF) formats.

18. The system of claim 14 wherein the UI supplies a text search term to the main application.

19. The system of claim 14 wherein the main application accepts a search term from the UI selected from the group including keywords, ASCII symbols, word patterns, and data patterns.

20. The system of claim 14 wherein the viewer application launches the OCR engine, prior to supplying the selected image file.

21. The system of claim 14 wherein the main application receives a plurality of image file references corresponding to the search term, and receives a command from the UI selecting an image file from among the plurality of image file references.

22. The system of claim 21 further comprising:
a plurality of viewer applications, each viewer application corresponding to image file format.

23. The system of claim 14 wherein the OCR engine locates a sequence of bytes in the image file corresponding to the search term and supplies the byte sequence location to the viewer application.
